(19) United States
(12) Patent Application Publication
(10) Pub. No.: US 2017/0316688 A1
(43) Pub. Date: Nov. 2, 2017

(54) VEHICLE SPEED PREDICTION METHOD

(71) Applicant: INSTITUTE FOR INFORMATION INDUSTRY, TAIPEI (TW)

(72) Inventors: Yuan-Cheng LAI, Hsinchu City (TW); Ssu-Fan WANG, New Taipei City (TW); Bor-Shen LIN, Taipei City (TW)

(21) Appl. No.: 15/186,533

(22) Filed: Jun. 19, 2016

(30) Foreign Application Priority Data
Apr. 28, 2016 (TW) 105113285

(51) Int. Cl. G08G 1/0968; G08G 1/052; G01C 21/34

(52) U.S. Cl. CPC G08G 1/096805; G01C 21/3492; G08G 1/052

(57) ABSTRACT

The present invention discloses a vehicle speed prediction method. The vehicle speed prediction method comprises the following steps: calculating a short-term predicted vehicle speed; calculating a long-term predicted vehicle speed; calculating a mixed predicted vehicle speed according to the short-term predicted vehicle speed and the long-term predicted vehicle speed; and calculating a route running time according to the predicted vehicle speed of each road of the route.

### RELATED APPLICATIONS

This application claims priority to Taiwan Application Serial Number 105113285, filed on Apr. 28, 2016, which is herein incorporated by reference.

### BACKGROUND

### Field of Invention

The present invention relates to a vehicle speed prediction method.

### Description of Related Art

The existing traffic prediction mechanism comprises artificial neural network calculation, data prospecting, machine-learning, statistical analysis, and fuzzy algorithm. The above traffic prediction mechanisms merely use long-term or short-term prediction. If only using short-term prediction, namely, just using short-term data to evaluate, as the prediction time increases, the accuracy will be reduced. However, if only using long-term prediction, namely, just using long-term data to evaluate, as traffic accident is appeared or be under construction, the long-term prediction system cannot reflect instantly. Therefore, the accuracy will also be reduced.

### SUMMARY

The present invention provides a vehicle speed prediction method. The present invention combines short-term and long-term vehicle speed data to evaluate the predicted vehicle speed and calculates the route running time according to a predicted vehicle speed of each road.

An aspect of the disclosure is to provide a vehicle speed prediction method, adapted for calculating a predicted vehicle speed at a predicted time for a selected road, wherein the vehicle speed prediction method is operated on a processing device, comprising the following steps: calculating a first predicted vehicle speed according to a short-term vehicle speed data through the processing device; calculating a second predicted vehicle speed according to a long-term vehicle speed data through the processing device; and multiplying the first predicted vehicle speed by a first weight, multiplying the second predicted vehicle speed by a second weight, and accumulating the above two results to obtain a mixed predicted vehicle speed through the processing device. Wherein the short-term vehicle speed data is defined as vehicle speed data of all vehicles driven on the selected road within a specific time frame before the predicted time, and the long-term vehicle speed data is defined as vehicle speed data of all vehicles driven on the selected road within at least one specific period before the predicted time.

In one embodiment of the present invention, wherein the specific period is defined as one day, one week, one month, or one year.

In one embodiment of the present invention, wherein a sum of the first weight and the second weight is one.

In one embodiment of the present invention, wherein the calculation steps of the first predicted vehicle speed are defined as follows: calculating an accumulation of multiplying a first statistical vehicle speed by a third weight at different time point; calculating an accumulation of multiplying a first error by a fourth weight at different time point; and calculating a sum of the above two results, and the sum is defined as the first predicted vehicle speed. Wherein the first error is defined as a difference between a real vehicle speed and a predicted vehicle speed at each time point, and the first statistical vehicle speed is defined as an average vehicle speed of all driven vehicles on the selected road at each time point.

In one embodiment of the present invention, wherein a value of the third weight at different time points is different, a value of the first statistical vehicle speed at different time points is different, a value of the fourth weight at different time points is different, and a value of the first error at different time points is different.

In one embodiment of the present invention, wherein the calculation steps of the second predicted vehicle speed are defined as follows: calculating an accumulation of multiplying a second statistical vehicle speed by a fifth weight at different time point; calculating an accumulation of multiplying a second error by a sixth weight at different time point; and calculating a sum of the above two results, and the sum is defined as the second predicted vehicle speed. Wherein the second error is defined as a difference between a real vehicle speed and a predicted vehicle speed at each time point, and the second statistical vehicle speed is defined as an average vehicle speed of all driven vehicles on the selected road at each time point.

In one embodiment of the present invention, wherein a value of the fifth weight at different time points is different, a value of the second statistical vehicle speed at different time points is different, a value of the sixth weight at different time points is different, and a value of the second error at different time points is different.

An aspect of the disclosure is to provide a vehicle speed prediction method, adapted for calculating a repeated-k-times mixed predicted vehicle speed at a predicted time for a selected road, wherein the vehicle speed prediction method is operated on a processing device and the k is a positive integer, comprising the following steps: calculating a repeated-k-times short-term predicted vehicle speed according to a short-term vehicle speed data through the processing device, wherein the short-term vehicle speed data is defined as vehicle speed data of all vehicles driven on the selected road within a specific time frame before the predicted time; calculating a repeated-k-times long-term predicted vehicle speed according to a long-term vehicle speed data through the processing device, wherein the long-term vehicle speed data is defined as vehicle speed data of all vehicles driven on the selected road within at least one specific period before the predicted time; and using the repeated-k-times short-term predicted vehicle speed and the repeated-k-times long-term predicted vehicle speed to calculate the repeated-k-times mixed predicted vehicle speed through the processing device, wherein the repeated-k-times mixed predicted vehicle speed is obtained through multiplying the repeated-k-times short-term predicted vehicle speed and the repeated-k-times long-term predicted vehicle speed by different weights respectively.

In one embodiment of the present invention, wherein steps of the repeated-k-times mixed predicted vehicle speed is obtained through multiplying the repeated-k-times short-term predicted vehicle speed and the repeated-k-times long-term predicted vehicle speed by different weights respectively comprises the following step: multiplying repeated-k-times short-term predicted vehicle speed by a first specific weight, multiplying repeated-k-times long-term predicted vehicle speed by a specific second weight, a sum of the above results is defined as the repeated-k-times mixed predicted vehicle speed, wherein the first specific weight is defined as the k^{th} power of x, the x is a numerical value that is greater than zero and smaller than one, and sum of the first specific weight and the second specific weight is one.

In one embodiment of the present invention, wherein the calculation steps of the repeated-k-times short-term predicted vehicle speed are defined as follows: calculating an accumulation of multiplying a repeated-(k−i)-times short-term predicted vehicle speed by a third specific weight at different time point; calculating an accumulation of multiplying a first statistical vehicle speed by a fourth specific weight at different time point; calculating an accumulation of multiplying a first predicted error by a fifth specific weight at different time point; calculating an accumulation of multiplying a first error by a sixth specific weight at different time point; and calculating a sum of the above four results, and the sum is defined as the repeated-k-times short-term predicted vehicle speed. Wherein the first error is defined as a difference between a real vehicle speed and a predicted vehicle speed at each time point, the i is a positive integer, and the first statistical vehicle speed is defined as an average vehicle speed of all driven vehicles on the selected road at each time point.

In one embodiment of the present invention, wherein a value of the third specific weight at different time points is different, a value of the repeated-(k−i)-times short-term predicted vehicle speed at different time points is different, a value of the fourth specific weight at different time points is different, a value of the first statistical vehicle speed at different time points is different, a value of the fifth specific weight at different time points is different, a value of the first predicted error at different time points is different, a value of the sixth specific weight at different time points is different, and a value of the first error at different time points is different.

In one embodiment of the present invention, wherein the calculation steps of the repeated-k-times long-term predicted vehicle speed are defined as follows: calculating an accumulation of multiplying a second statistical vehicle speed by a seventh specific weight at different time point; calculating an accumulation of multiplying a second error by a eighth specific weight at different time point; and calculating a sum of the above two results, and the sum is defined as the repeated-k-times long-term predicted vehicle speed. Wherein the second error is defined as a difference between a real vehicle speed and a predicted vehicle speed at each time point, the i is a positive integer, and the second statistical vehicle speed is defined as an average vehicle speed of all driven vehicles on the selected road at each time point.

In one embodiment of the present invention, wherein a value of the seventh specific weight at different time points is different, a value of the second statistical vehicle speed at different time points is different, a value of the eighth specific weight at different time points is different, and a value of the second error at different time points is different.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a flowchart of the vehicle speed prediction method according to the first embodiment of the present invention;

FIG. 2 is a flowchart of the vehicle speed prediction method according to the second embodiment of the present invention;

FIG. 3 is a schematic diagram of short-term predicted vehicle speed calculation according to the second embodiment of the present invention; and

FIG. 4 is a schematic diagram of long-term predicted vehicle speed calculation according to the second embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The present invention provides a vehicle speed prediction method. The present invention combines short-term and long-term vehicle speed data to evaluate the predicted vehicle speed and calculates the route running time according to a predicted vehicle speed of each road.

The vehicle speed prediction method is divided into three steps: a collecting step, a model-building step, and a prediction step.

At the collecting step, the vehicle speed prediction method of the present invention collects historical data of vehicle speed for each road in the city.

Next, the model-building step is operated. In this step, firstly, the short-term predicted vehicle speed and the long-term predicted vehicle speed are calculated respectively. In the vehicle speed prediction method of the present invention, each road is an independent object. The vehicle speed prediction method of the present invention builds ARIMA (Autoregressive Integrated Moving Average) model by using historical data of vehicle speed for each road and uses least square mathematic method to obtain parameters of the ARIMA model.

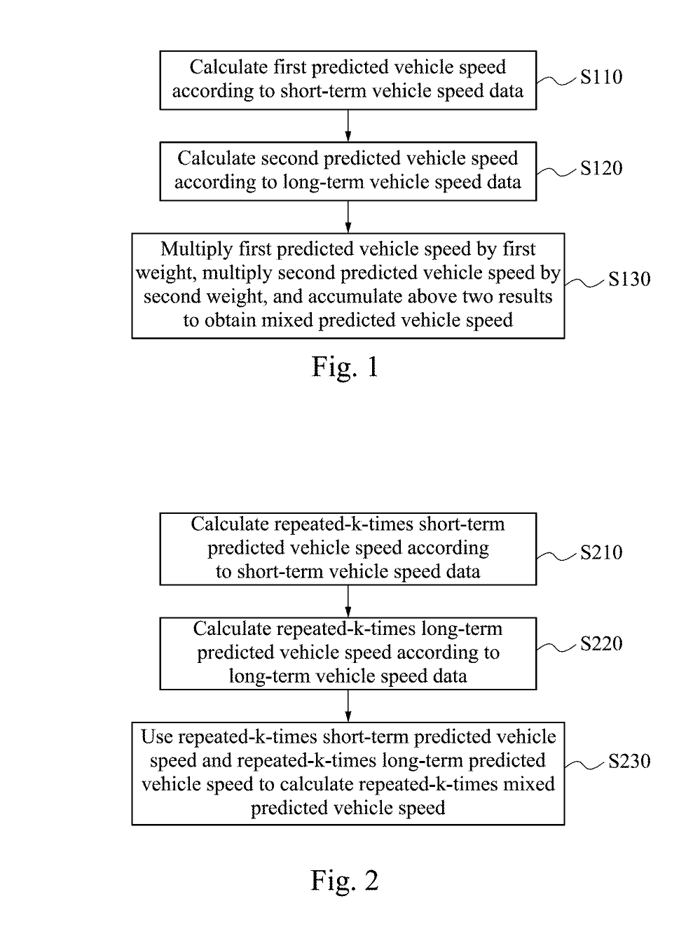

FIG. 1 is a flowchart of the vehicle speed prediction method according to the first embodiment of the present invention. The embodiment is adapted for calculating a predicted vehicle speed at a predicted time for a selected road, wherein the vehicle speed prediction method is operated on a processing device. Referring to FIG. 1, firstly, the processing device calculates a first predicted vehicle speed according to a short-term vehicle speed data (Step S110). Next, the processing device calculates a first predicted vehicle speed according to a short-term vehicle speed data (Step S120). Next, the processing device multiplies the first predicted vehicle speed by a first weight, multiplies the second predicted vehicle speed by a second weight and accumulates the above two results to obtain a mixed predicted vehicle speed (Step S130). The short-term vehicle speed data is defined as vehicle speed data of all vehicles driven on the selected road within a specific time frame before the predicted time, and the long-term vehicle speed data is defined as vehicle speed data of all vehicles driven on the selected road within at least one specific period before the predicted time. The specific period is defined as one day, one week, one month, or one year. A sum of the first weight and the second weight is one.

The calculation steps of the first predicted vehicle speed are defined as follows: calculating an accumulation of multiplying a first statistical vehicle speed by a third weight at different time point; calculating an accumulation of multiplying a first error by a fourth weight at different time point; and calculating a sum of the above two results, and the sum is defined as the first predicted vehicle speed. Wherein the first error is defined as a difference between a real vehicle speed and a predicted vehicle speed at each time point, and the first statistical vehicle speed is defined as an average vehicle speed of all driven vehicles on the selected road at each time point. The value of the third weight at different time points is different, the value of the first statistical vehicle speed at different time points is different, the value of the fourth weight at different time points is different, and the value of the first error at different time points is different.

The calculation steps of the second predicted vehicle speed are defined as follows: calculating an accumulation of multiplying a second statistical vehicle speed by a fifth weight at different time point; calculating an accumulation of multiplying a second error by a sixth weight at different time point; and calculating a sum of the above two results, and the sum is defined as the second predicted vehicle speed. Wherein the second error is defined as a difference between a real vehicle speed and a predicted vehicle speed at each time point, and the second statistical vehicle speed is defined as an average vehicle speed of all driven vehicles on the selected road at each time point. The value of the fifth weight at different time points is different, the value of the second statistical vehicle speed at different time points is different, the value of the sixth weight at different time points is different, and the value of the second error at different time points is different.

FIG. 2 is a flowchart of the vehicle speed prediction method according to the second embodiment of the present invention. The embodiment is adapted for calculating a repeated-k-times mixed predicted vehicle speed at a predicted time for a selected road, wherein the vehicle speed prediction method is operated on a processing device and the k is a positive integer. Referring to FIG. 2, firstly, the processing device calculates a repeated-k-times short-term predicted vehicle speed according to a short-term vehicle speed data through the processing device (Step S210), wherein the short-term vehicle speed data is defined as vehicle speed data of all vehicles driven on the selected road within a specific time frame before the predicted time. Next, the processing device calculates a repeated-k-times long-term predicted vehicle speed according to a long-term vehicle speed data (Step S220), wherein the long-term vehicle speed data is defined as vehicle speed data of all vehicles driven on the selected road within at least one specific period before the predicted time. Next, the processing device uses the repeated-k-times short-term predicted vehicle speed and the repeated-k-times long-term predicted vehicle speed to calculate the repeated-k-times mixed predicted vehicle speed through the processing device (Step S230), wherein the repeated-k-times mixed predicted vehicle speed is obtained through multiplying the repeated-k-times short-term predicted vehicle speed and the repeated-k-times long-term predicted vehicle speed by different weights respectively. The step S230 is operated through multiplying the repeated-k-times short-term predicted vehicle speed and the repeated-k-times long-term predicted vehicle speed by different weights respectively comprises the following step: multiplying repeated-k-times short-term predicted vehicle speed by a first specific weight, multiplying repeated-k-times long-term predicted vehicle speed by a specific second weight, a sum of the above results is defined as the repeated-k-times mixed predicted vehicle speed, wherein the first specific weight is defined as the k^{th} power of x, the x is a numerical value that is greater than zero and smaller than one, and sum of the first specific weight and the second specific weight is one.

The calculation steps of the repeated-k-times short-term predicted vehicle speed are defined as follows: calculating an accumulation of multiplying a repeated-(k−i)-times short-term predicted vehicle speed by a third specific weight at different time point; calculating an accumulation of multiplying a first statistical vehicle speed by a fourth specific weight at different time point; calculating an accumulation of multiplying a first predicted error by a fifth specific weight at different time point; calculating an accumulation of multiplying a first error by a sixth specific weight at different time point; and calculating a sum of the above four results, and the sum is defined as the repeated-k-times short-term predicted vehicle speed. Wherein the first error is defined as a difference between a real vehicle speed and a predicted vehicle speed at each time point, the i is a positive integer, and the first statistical vehicle speed is defined as an average vehicle speed of all driven vehicles on the selected road at each time point. The value of the third specific weight at different time points is different, the value of the repeated-(k−i)-times short-term predicted vehicle speed at different time points is different, the value of the fourth specific weight at different time points is different, the value of the first statistical vehicle speed at different time points is different, the value of the fifth specific weight at different time points is different, the value of the first predicted error at different time points is different, the value of the sixth specific weight at different time points is different, and the value of the first error at different time points is different.

The calculation steps of the repeated-k-times long-term predicted vehicle speed are defined as follows: calculating an accumulation of multiplying a second statistical vehicle speed by a seventh specific weight at different time point; calculating an accumulation of multiplying a second error by a eighth specific weight at different time point; and calculating a sum of the above two results, and the sum is defined as the repeated-k-times long-term predicted vehicle speed. Wherein the second error is defined as a difference between a real vehicle speed and a predicted vehicle speed at each time point, the i is a positive integer, and the second statistical vehicle speed is defined as an average vehicle speed of all driven vehicles on the selected road at each time point. The value of the seventh specific weight at different time points is different, the value of the second statistical vehicle speed at different time points is different, the value of the eighth specific weight at different time points is different, and the value of the second error at different time points is different.

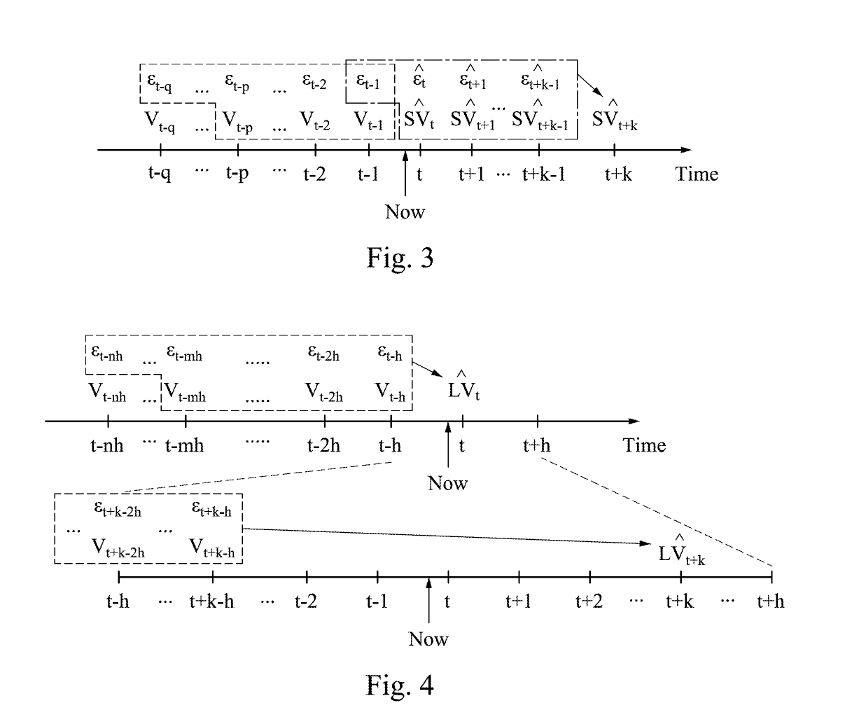

Next, the vehicle speed prediction method can be explained with one practical example. FIG. 3 is a schematic diagram of short-term predicted vehicle speed calculation according to the second embodiment of the present invention. FIG. 4 is a schematic diagram of long-term predicted vehicle speed calculation according to the second embodiment of the present invention. Firstly, the vehicle speed prediction method of the present invention calculates the short-term predicted vehicle speed [symbol] ₜ, and the unit time can be set as five minutes or set according to users' requirements. The predicted vehicle speed [symbol] ₜ at time t can be obtained by the following formula (1). Vₜ₋ᵢ is defined as the real vehicle speed at time (t−i), and E is defined as an error between the real vehicle speed and the predicted vehicle speed at time (t−i). To predict the short-term predicted vehicle speed [symbol] ₜ at time t, firstly, multiply Vₜ₋ᵢ by weight φᵢ, and then multiply εₜ₋ᵢ by θᵢ. Next, accumulate p pieces of φᵢVₜ₋ᵢ and q pieces of θᵢεₜ₋ᵢ. The weight parameters φᵢ and θᵢ can be calculated by historical statistical data. The predicted vehicle speed and the real vehicle speed are known. A plurality of the set (φᵢ, θᵢ) can be obtained by using the formula (1) to calculate the historical statistical data. Next, the present invention uses the least squares method to get the best (φᵢ, θᵢ).

$$\hat{{SV}_{t}} = {\sum }_{i = 1}^{P} {φ}_{i} {V}_{t - i} + {{\sum }_{i = 1}}^{q} {θ}_{i} {ɛ}_{t - i} \qquad ( 1 )$$

However, the accuracy will be reduced since the predicted time increases. The formula (2) defines that predicting the short-term predicted vehicle speed with k times repeatedly to generate the short-term predicted vehicle speed S\hat{V}ₜ₊ₖ at time (t+k). In the formula (2), φᵢ, φᵢ₊₁, θᵢ, and θᵢ₊₁ are weight parameters, and these parameters can be obtained by calculating the historical statistical data.

$$S {\hat{V}}_{t + k - i}$$

is defined as the short-term predicted vehicle speed at time (t+k−i). Vₜ₊ₖ₋₁₋ᵢ is defined as a real vehicle speed at time (t+k−1−i).

$${\hat{ɛ}}_{t + k - i}$$

is defined as the predicted error between the real vehicle speed and the predicted vehicle speed at time (t+k−i). εₜ₊ₖ₋₁₋ᵢ is defined as the error between the real vehicle speed and the predicted vehicle speed at time (t+k−1−i).

$$\hat{{SV}_{t + k}} = {{\sum }_{i = 1}}^{k} {φ}_{i} \hat{{SV}_{t + k - i}} + {\sum }_{i = k}^{p - 1} {φ}_{i + 1} {V}_{t + k - 1 - i} + {\sum }_{i = 1}^{k} {θ}_{i} \hat{{ɛ}_{t + k - i}} + {\sum }_{i = k}^{q - 1} {θ}_{i + 1} {ɛ}_{t + k - 1 - i} \qquad ( 2 )$$

Next, the vehicle speed prediction method of the present invention calculates the long-term predicted vehicle speed [symbol] , and the unit time can be set as one day or set according to users' requirements. The predicted vehicle speed [symbol] at time t can be obtained by the following formula (3). V_{t-i×h} is defined as the real vehicle speed at time (t−i×h). ε_{t-i×h} is defined as an error between the real vehicle speed and the predicted vehicle speed at time (t−i×h). To predict the long-term predicted vehicle speed [symbol] at time t, firstly, multiply V_{t-i×h} by weight and then multiply ε_{t-i×h} by μᵢ. Next, accumulate m pieces of λᵢ V_{t-i×h} and n pieces of μᵢε_{t-i×h}. The weight parameters λᵢ and μᵢ can be calculated by historical statistical data. The predicted vehicle speed and the real vehicle speed are known. A plurality of the set (λᵢ, μᵢ) can be obtained by using the formula (3) to calculate the historical statistical data. Next, the present invention uses the least squares method to get the best (λᵢ, μᵢ).

$$\hat{{LV}_{t}} = {\sum }_{i = 1}^{m} {λ}_{i} {V}_{t - i \times h} + {\sum }_{i = 1}^{n} {μ}_{i} {ɛ}_{i - i \times h} \qquad ( 3 )$$

The following formula (4) defines that predicting the long-term predicted vehicle speed with k times repeatedly to generate the long-term predicted vehicle speed L\hat{V}ₜ₊ₖ at time (t+k). In the formula (4), λᵢ, and μᵢ are weight parameters, and these parameters can be obtained by calculating the historical statistical data. V_{t+k×h} is defined as a real vehicle speed at time (t+k−i×h). ε_{t+k-i×h} is defined as the error between the real vehicle speed and the predicted vehicle speed at time (t+k−i×h).

$$\hat{{LV}_{t + k}} = {\sum }_{i = 1}^{m} {λ}_{i} {V}_{t + k - i \times h} + {\sum }_{i = 1}^{n} {μ}_{i} {ɛ}_{t + k - i \times h} \qquad ( 4 )$$

After calculating the short-term and long-term predicted vehicle speed, the predicted results are mixed to generate the mixed predicted vehicle speed \hat{V}ₜ, defined as the following formula (5). αₜ is a weight parameter, and the value of αₜ is greater than zero and smaller than 1. The value of αₜ will be distinct at different time point. For limiting the quantity of αₜ, the length of t is limited within one day, as \tilde{t} defined in the formula (6). For example, the value of at are different at 12:00 PM, 12:05 PM, and 12:10 PM today. However, the value of αₜ are the same at 12:00 PM today and at 12:00 PM at tomorrow, the value of αₜ are the same at 12:05 PM today and at 12:05 PM at tomorrow, and the value of at are the same at 12:10 PM today and at 12:10 PM at tomorrow.

\hat{V}ₜ=αₜ [symbol] ₜ+(1−αₜ) [symbol] (5)

\tilde{t}=t mod h (6)

The repeated-k-times mixed predicted vehicle speed [symbol] is defined as the following formula (7). Since the prediction period becomes longer,

$${\sum }_{i = 0}^{k} {α}_{\hat{t + i}}$$

becomes smaller. Therefore, the ratio of S\hat{V}ₜ₊ₖ to [symbol] becomes lower, and the ratio of L\hat{V}ₜ₊ₖ becomes higher. When k is equal to a threshold ‘x’, it is only to calculate the long-term predicted vehicle speed, as disclosed in formula (8). For the value of x, if the weight parameter [symbol] of S\hat{V}ₜ₊ₖ is smaller than 0.1, the k is equal to the threshold x. If k is smaller than x, the repeated-k-times mixed predicted vehicle speed [symbol] is defined as the following formula (7). If k is greater than or equal to x, the repeated-k-times mixed predicted vehicle speed [symbol] is defined as the following formula (8).

$$\begin{matrix}\hat{{V}_{t + k}} = {\prod }_{i = 0}^{k} {α}_{\hat{t + i}} S \hat{{V}_{t + k}} + ( 1 - {\prod }_{i = 0}^{k} {α}_{\hat{t + i}} ) \hat{{LV}_{t + k}} & ( 7 ) \\ \hat{{V}_{t + k}} = \hat{{LV}_{t + k}} & ( 8 )\end{matrix}$$

The present invention uses the weight parameter α_{t\tilde{+} i} to adjust the ratio of short-term predicted vehicle speed and the ratio of long-term predicted vehicle speed to the mixed predicted vehicle speed. For calculating the weight parameter α_{t\tilde{+} i}, the present invention calculates historical statistical data and uses least squares method to obtain these weight parameters (α_{\grave{t}}, α_{t\grave{+} 1} . . . α_{t\tilde{+} k}).

A route can be divided into a plurality of roads r₁, r₂, r₃, and . . . r_{z}, and the related road length are d₁, d₂, d₃, and . . . d_{z} respectively. The related predicted vehicle speed at time t are \hat{V}ₜ¹, \hat{V}ₜ², \hat{V}ₜ³, . . . \hat{V}ₜ^{z} respectively. The formula (9) explains how to calculate the required running time π₁ of road r₁. The formula (10) explains how to calculate the required running time πᵢ of road rᵢ. Finally, the required running time T of the whole route is defined as a sum of the required running time of each road, as disclosed in formula (11).

$$\begin{matrix}{π}_{1} = \frac{{d}_{1}}{{\hat{V}}_{t}^{1}} & ( 9 ) \\ {π}_{i} = \frac{{d}_{i}}{{\hat{V}}_{t + {\sum }_{j = 1}^{i - 1} {π}_{j}}^{i}} & ( 10 ) \\ T = {\sum }_{i = 1}^{z} {π}_{i} & ( 11 )\end{matrix}$$

The ARIMA model built at the model-building step can obtain the short-term predicted vehicle speed and the long-term predicted vehicle speed according to an input time and an input route at the prediction step. Next, the present invention uses the above formula (7) to get the predicted vehicle speed. Next, the present invention predicts the route running time according to the predicated speed and the related distance for each road.

Since the traffic flow increase year by year, it is important that how to operate traffic prediction so as to save time and reduce power consuming accurately and efficiently. The great vehicle speed prediction method and running time prediction method not only help vehicle drivers to plan vehicle route but also help to relieve traffic congestion and improve the traffic situation. The vehicle speed prediction method of the present invention comprises two advantages: steady of long-term prediction and reflecting temporary changes of short-term prediction. The vehicle speed prediction method of the present invention considers the short-term correlation and long-term correlation at the same time. Comparing to the traditional vehicle speed prediction method, the vehicle speed prediction method of the present invention is more accurate.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A vehicle speed prediction method, adapted for calculating a predicted vehicle speed at a predicted time for a selected road, wherein the vehicle speed prediction method is operated on a processing device, comprising the following steps:
(A) calculating a first predicted vehicle speed according to a short-term vehicle speed data through the processing device;
(B) calculating a second predicted vehicle speed according to a long-term vehicle speed data through the processing device; and
(C) multiplying the first predicted vehicle speed by a first weight, multiplying the second predicted vehicle speed by a second weight, and accumulating the above two results to obtain a mixed predicted vehicle speed through the processing device;
wherein the short-term vehicle speed data is defined as vehicle speed data of all vehicles driven on the selected road within a specific time frame before the predicted time, and the long-term vehicle speed data is defined as vehicle speed data of all vehicles driven on the selected road within at least one specific period before the predicted time.

2. The vehicle speed prediction method of claim 1, wherein the specific period is defined as one day, one week, one month, or one year.

3. The vehicle speed prediction method of claim 1, wherein a sum of the first weight and the second weight is one.

4. The vehicle speed prediction method of claim 1, wherein the calculation steps of the first predicted vehicle speed are defined as follows:
calculating an accumulation of multiplying a first statistical vehicle speed by a third weight at different time point;
calculating an accumulation of multiplying a first error by a fourth weight at different time point; and
calculating a sum of the above two results, and the sum is defined as the first predicted vehicle speed;
wherein the first error is defined as a difference between a real vehicle speed and a predicted vehicle speed at each time point, and the first statistical vehicle speed is defined as an average vehicle speed of all driven vehicles on the selected road at each time point.

5. The vehicle speed prediction method of claim 4, wherein a value of the third weight at different time points is different, a value of the first statistical vehicle speed at different time points is different, a value of the fourth weight at different time points is different, and a value of the first error at different time points is different.

6. The vehicle speed prediction method of claim 1, wherein the calculation steps of the second predicted vehicle speed are defined as follows:
calculating an accumulation of multiplying a second statistical vehicle speed by a fifth weight at different time point;
calculating an accumulation of multiplying a second error by a sixth weight at different time point; and
calculating a sum of the above two results, and the sum is defined as the second predicted vehicle speed;
wherein the second error is defined as a difference between a real vehicle speed and a predicted vehicle speed at each time point, and the second statistical vehicle speed is defined as an average vehicle speed of all driven vehicles on the selected road at each time point.

7. The vehicle speed prediction method of claim 6, wherein a value of the fifth weight at different time points is different, a value of the second statistical vehicle speed at different time points is different, a value of the sixth weight at different time points is different, and a value of the second error at different time points is different.

8. A vehicle speed prediction method, adapted for calculating a repeated-k-times mixed predicted vehicle speed at a predicted time for a selected road, wherein the vehicle speed prediction method is operated on a processing device and the k is a positive integer, comprising the following steps:
calculating a repeated-k-times short-term predicted vehicle speed according to a short-term vehicle speed data through the processing device, wherein the short-term vehicle speed data is defined as vehicle speed data of all vehicles driven on the selected road within a specific time frame before the predicted time;
calculating a repeated-k-times long-term predicted vehicle speed according to a long-term vehicle speed data through the processing device, wherein the long-term vehicle speed data is defined as vehicle speed data of all vehicles driven on the selected road within at least one specific period before the predicted time; and
using the repeated-k-times short-term predicted vehicle speed and the repeated-k-times long-term predicted vehicle speed to calculate the repeated-k-times mixed predicted vehicle speed through the processing device, wherein the repeated-k-times mixed predicted vehicle speed is obtained through multiplying the repeated-k-times short-term predicted vehicle speed and the repeated-k-times long-term predicted vehicle speed by different weights respectively.

9. The vehicle speed prediction method of claim 8, wherein steps of the repeated-k-times mixed predicted vehicle speed is obtained through multiplying the repeated-k-times short-term predicted vehicle speed and the repeated-k-times long-term predicted vehicle speed by different weights respectively comprises the following step:
multiplying repeated-k-times short-term predicted vehicle speed by a first specific weight, multiplying repeated-k-times long-term predicted vehicle speed by a specific second weight, a sum of the above results is defined as the repeated-k-times mixed predicted vehicle speed, wherein the first specific weight is defined as the k^{th} power of x, the x is a numerical value that is greater than zero and smaller than one, and sum of the first specific weight and the second specific weight is one.

10. The vehicle speed prediction method of claim 9, wherein the calculation steps of the repeated-k-times short-term predicted vehicle speed are defined as follows:
calculating an accumulation of multiplying a repeated-(k−i)-times short-term predicted vehicle speed by a third specific weight at different time point;
calculating an accumulation of multiplying a first statistical vehicle speed by a fourth specific weight at different time point;
calculating an accumulation of multiplying a first predicted error by a fifth specific weight at different time point;
calculating an accumulation of multiplying a first error by a sixth specific weight at different time point; and
calculating a sum of the above four results, and the sum is defined as the repeated-k-times short-term predicted vehicle speed;
wherein the first error is defined as a difference between a real vehicle speed and a predicted vehicle speed at each time point, the i is a positive integer, and the first statistical vehicle speed is defined as an average vehicle speed of all driven vehicles on the selected road at each time point.

11. The vehicle speed prediction method of claim 10, wherein a value of the third specific weight at different time points is different, a value of the repeated-(k−i)-times short-term predicted vehicle speed at different time points is different, a value of the fourth specific weight at different time points is different, a value of the first statistical vehicle speed at different time points is different, a value of the fifth specific weight at different time points is different, a value of the first predicted error at different time points is different, a value of the sixth specific weight at different time points is different, and a value of the first error at different time points is different.

12. The vehicle speed prediction method of claim 9, wherein the calculation steps of the repeated-k-times long-term predicted vehicle speed are defined as follows:
calculating an accumulation of multiplying a second statistical vehicle speed by a seventh specific weight at different time point;
calculating an accumulation of multiplying a second error by a eighth specific weight at different time point; and
calculating a sum of the above two results, and the sum is defined as the repeated-k-times long-term predicted vehicle speed;
wherein the second error is defined as a difference between a real vehicle speed and a predicted vehicle speed at each time point, the i is a positive integer, and the second statistical vehicle speed is defined as an average vehicle speed of all driven vehicles on the selected road at each time point.

13. The vehicle speed prediction method of claim 12, wherein a value of the seventh specific weight at different time points is different, a value of the second statistical vehicle speed at different time points is different, a value of the eighth specific weight at different time points is different, and a value of the second error at different time points is different.
